(19) United States
(12) Patent Application Publication
(10) Pub. No.: US 2013/0057483 A1
(43) Pub. Date: Mar. 7, 2013

(54) INPUT DEVICE AND MONITOR HAVING THE SAME

(71) Applicants: KUO-CHAN PENG, PINGZHEN CITY (TW); CHING-FENG HSIEH, TAIPEI CITY (TW)

(72) Inventors: KUO-CHAN PENG, PINGZHEN CITY (TW); CHING-FENG HSIEH, TAIPEI CITY (TW)

(73) Assignees: ASKEY COMPUTER CORP.; ASKEY TECHNOLOGY (JIANGSU) LTD.

(21) Appl. No.: 13/279,677

(22) Filed: Oct. 24, 2011

(30) Foreign Application Priority Data
Sep. 6, 2011 (TW) 100132108

(51) Int. Cl. G06F 3/041

(52) U.S. Cl. 345/173

(57) ABSTRACT

An input device and a monitor having the input device are for use in a portable electronic device. The monitor of the portable electronic device has a touch display panel capable of touch control. Disposed on the touch display panel is a physical input unit functionally corresponding to a touch input unit displayed on the monitor. The touch input unit is configured by a programmable procedure, such that the touch input unit is linked to an application. A user executes the application by pressing the physical input unit and touching indirectly the touch input unit. Even if it is impossible for the application to be activated by the touch input unit, the application can still be executed by the physical input unit. Even if it is impossible for the application to be activated by the physical input unit, the application can still be executed by the touch input unit.

### CROSS-REFERENCE TO RELATED APPLICATION

This non-provisional application claims priority under 35 U.S.C. §119(a) on Patent Application No(s).100132108 filed in Taiwan, R.O.C. on Sep. 6, 2011, the entire contents of which are hereby incorporated by reference.

### FIELD OF TECHNOLOGY

The present invention relates to display devices, and more particularly, to a monitor having a touch input unit and a physical input unit.

### BACKGROUND

Portable electronic devices with a touch panel, such as smartphones and tablet computers, are in wide use today. A user touches the touch panel to generate a touch signal whereby applications in the portable electronic device are executed. Strictly speaking, icons of the applications are displayed on the touch panel of the portable electronic device, and the user touches the icons displayed on the touch panel to execute the applications linked to the icons.

However, the odds are that the touch control of the touch panel may fail and thereby prevent the user from executing the applications by touch control, thereby ending up in a situation no different from a breakdown.

In view of the aforesaid drawbacks of the prior art, the present invention provides a method and device for controlling materialization of a programmable virtual key.

### SUMMARY

It is an objective of the present invention to provide an input device and a monitor having the input device, wherein a programmable touch input unit and a physical input unit together enable stable execution of applications disposed in a portable electronic device.

In order to achieve the above and other objectives, the present invention provides an input device comprising a touch input unit, a physical input unit, and a control unit. The touch input unit generates a touch signal. The physical input unit is superimposed on the touch input unit. The physical input unit is spaced apart from the touch input unit by a distance. The physical input unit generates a control signal. The control unit is electrically connected to the physical input unit and the touch input unit. The control unit activates an action based on the control signal and the touch signal.

In order to achieve the above and other objectives, the present invention provides a monitor having an input device. The monitor comprises a touch display panel, a physical input unit, and a control unit. The touch display panel displays a touch input unit adapted to generate a touch signal. The physical input unit is disposed on the touch display panel. The physical input unit is superimposed on the touch input unit. The physical input unit is spaced apart from the touch display panel by a distance. The physical input unit is adapted to generate a control signal. The control unit is electrically connected to the physical input unit and the touch display panel. The control unit activates an action based on the control signal and the touch signal.

Compared with the prior art, the present invention provides an input device and a monitor having the input device, wherein the coupling of a touch input unit and a physical input unit enables the applications to be executed by means of the physical input unit even if it is impossible for the applications to be activated by the touch input unit and enables the applications to be executed by means of the touch input unit even if it is impossible for the applications to be activated by the physical input unit, thereby preventing a breakdown which might otherwise happen because the applications cannot be executed as a result of a failure of the touch input unit or the physical input unit.

### BRIEF DESCRIPTION

Objectives, features, and advantages of the present invention are hereunder illustrated with specific embodiments in conjunction with the accompanying drawings, in which:

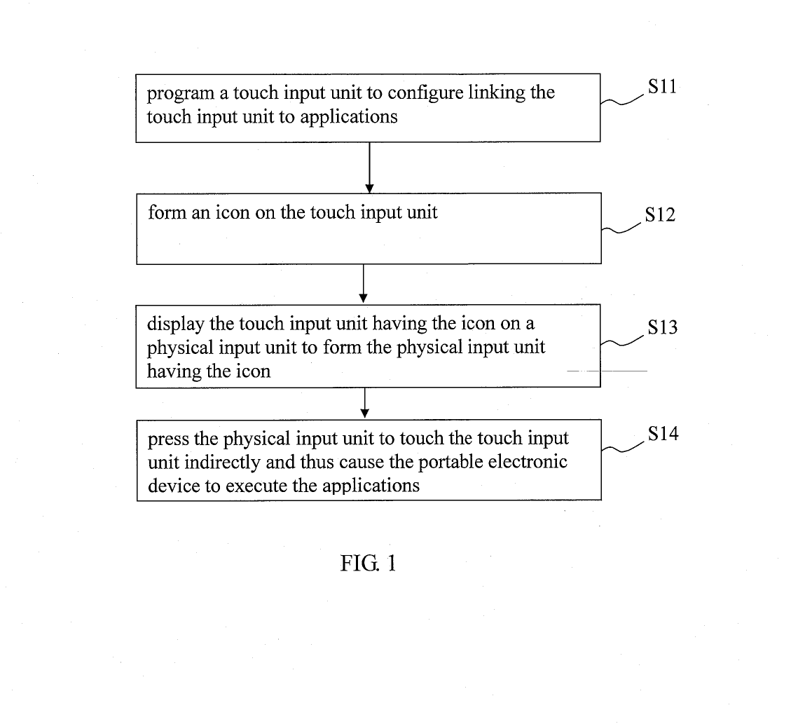

FIG. 1 is a flow chart of a method for operating an input device and a monitor having the input device according to the first embodiment of the present invention;

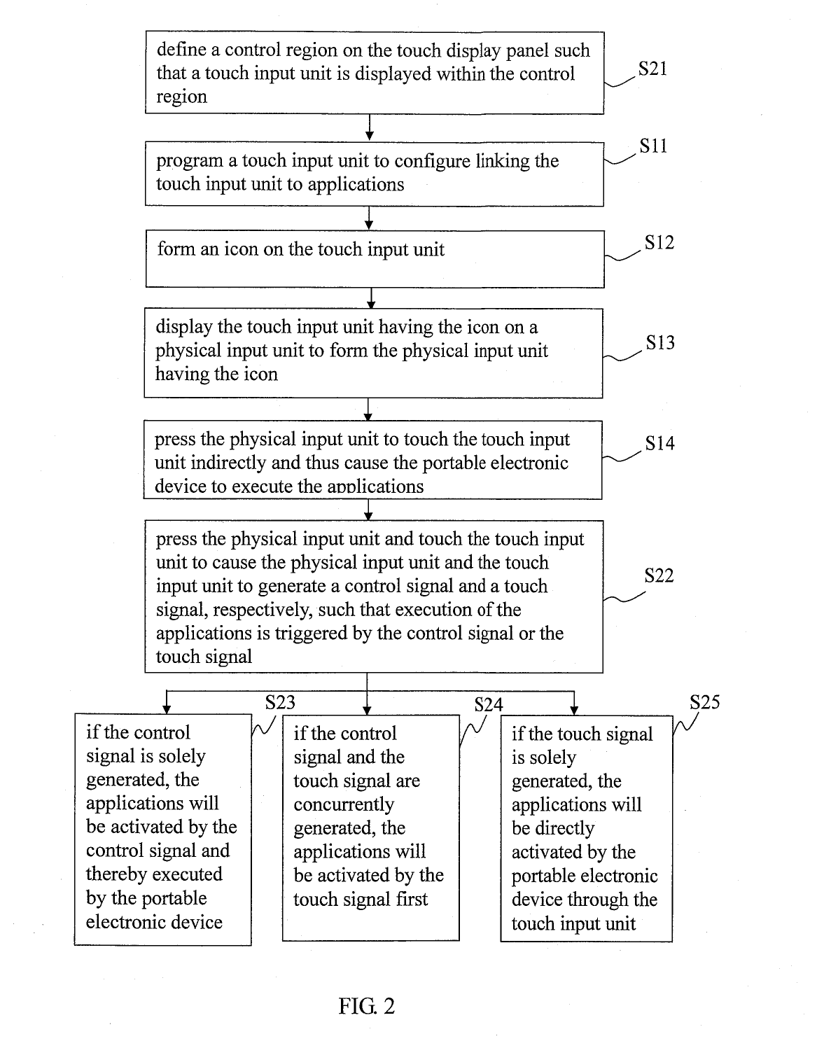

FIG. 2 is a flow chart of a method for operating an input device and a monitor having the input device according to the second embodiment of the present invention;

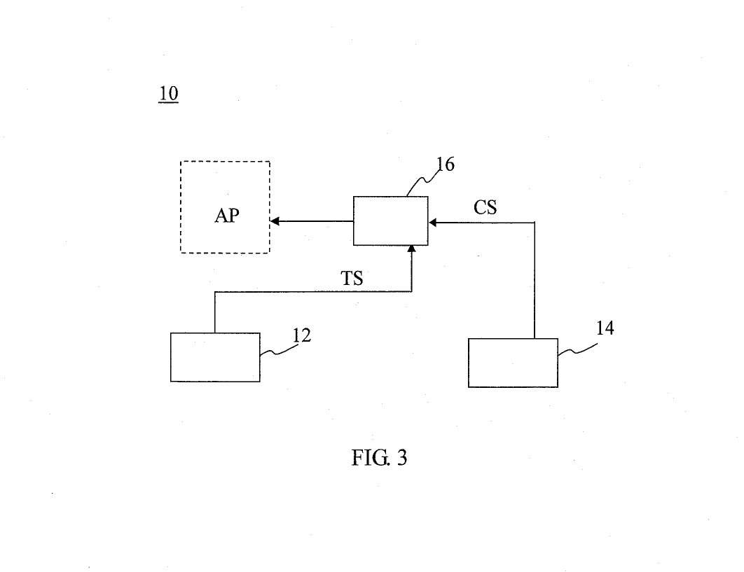

FIG. 3 is a schematic view of the input device according to the first embodiment of the present invention;

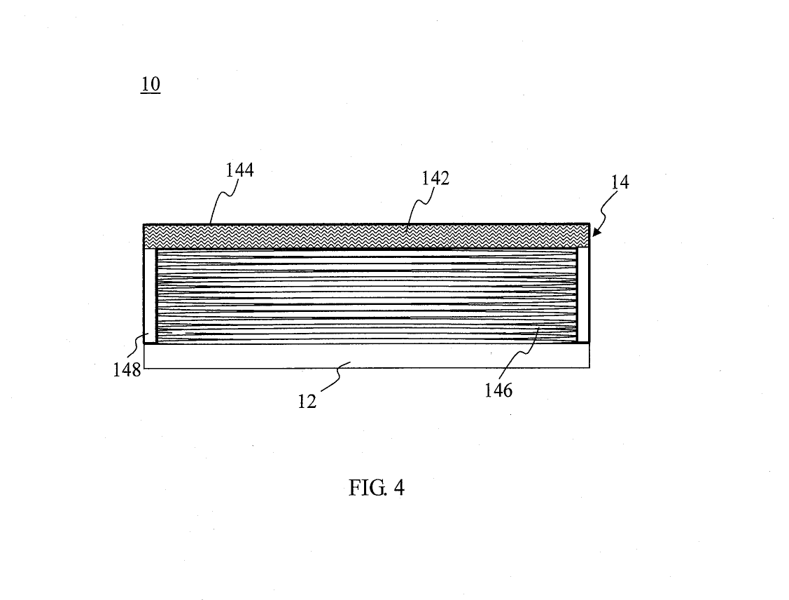

FIG. 4 is a schematic view of the detailed structure of a physical input unit in FIG. 3;

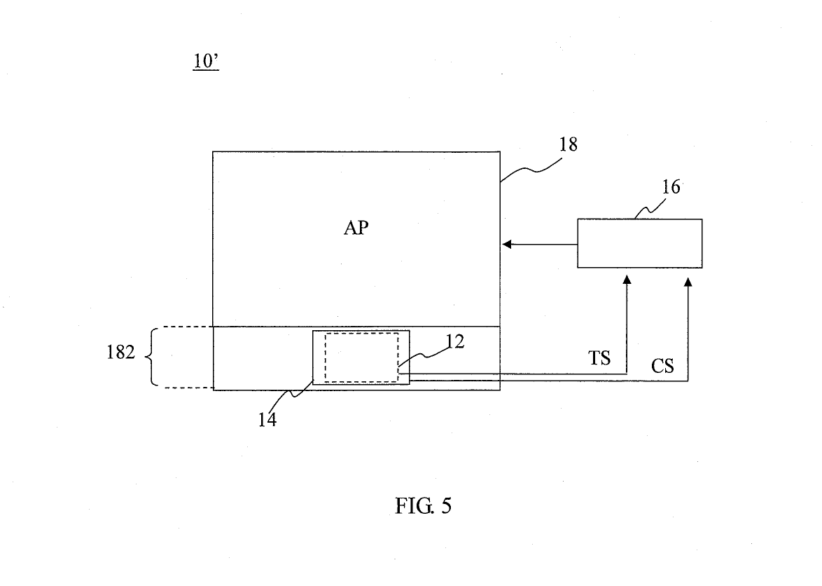

FIG. 5 is a schematic view of the input device according to the second embodiment of the present invention; and

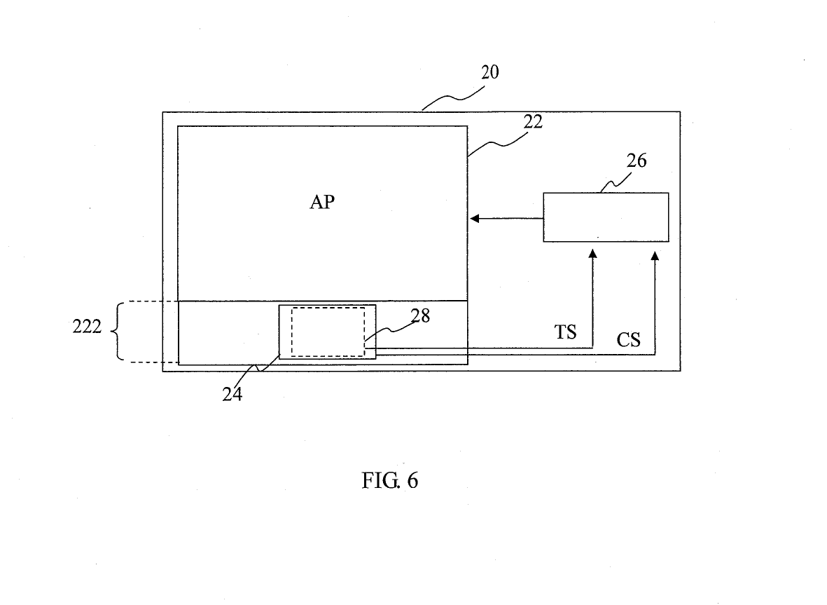

FIG. 6 is a schematic view of a monitor having an input device according to the first embodiment of the present invention.

### DETAILED DESCRIPTION

Referring to FIG. 1, there is shown a flow chart of a method for operating an input device and a monitor having the input device according to the first embodiment of the present invention. As shown in FIG. 1, the method involves displaying a touch input unit on a touch display panel of a portable electronic device, superimposing a physical input unit on the touch input unit, and executing a plurality of applications installed on the portable electronic device as soon as a user touches the touch input unit indirectly through the physical input unit. The process flow of the method starts with step S11 which involves programming a touch input unit through a portable electronic device to configure linking the touch input unit to the applications. As a result, once the user touches the touch input unit, the applications linked to the touch input unit will be executed.

In step S12, an icon for indicating that the touch input unit can be linked to the applications is formed on the touch input unit. Strictly speaking, to enable the user to gain insight into the applications linked to the touch input unit, it is feasible to form an icon on the touch input unit, such that the user readily understands the intended functions of the applications by making reference to the icon.

In step S13, the touch input unit having the icon is displayed on the physical input unit to form the physical input unit having the icon. To be precise, the icon of the touch input unit is directly displayed on the physical input unit, such that the physical input unit bears the same icon as the touch input unit does.

Step S14 involves pressing the physical input unit to touch the touch input unit indirectly and thus cause the portable electronic device to execute the applications. In an embodiment, when pressed, the physical input unit comes into contact with the touch input unit disposed beneath the physical input unit, such that the applications linked to the touch input unit are executed. In another embodiment, when pressed, the physical input unit not only comes into contact with the touch input unit but also plays a role in executing the applications, such that the portable electronic device can execute the applications by either the touch input unit or the physical input unit.

Referring to FIG. 2, there is shown a flow chart of a method for operating an input device and a monitor having the input device according to the second embodiment of the present invention. As shown in FIG. 2, the method further comprises step S11 through S14, and further comprises step S21 that precedes the step S11. Step S21 involves defining a control region on the touch display panel such that the touch input unit is displayed within the control region. Strictly speaking, in step S21, the touch display panel has a region defined thereon for displaying the touch input unit and has the physical input unit thereon.

At the end of step S14, both the physical input unit and the touch input unit can activate the generation of a related signal for executing the applications; hence, the method further comprises step S22 that follows step S14. In step S22, pressing the physical input unit and touching the touch input unit causes the physical input unit and the touch input unit to generate a control signal and a touch signal, respectively, such that the execution of the applications is triggered by means of the control signal or the touch signal.

In step S23, if the control signal is solely generated (when the touch input unit breaks down and thus fails to generate the touch signal by contact, for example), the applications will be activated by the control signal and thereby executed by the portable electronic device.

In step S24, if the control signal and the touch signal are concurrently generated, the applications will be activated by the touch signal first. Strictly speaking, in step S24, the physical input unit plays an indirect role in executing the applications by coming into contact with the touch input unit.

In step S25, if the touch signal is solely generated (when the physical input unit breaks down and thus fails to generate the control signal when pressed, for example), the applications will be directly activated by the portable electronic device through the touch input unit.

Hence, the purpose of step S24 through S25 is to determine whether the applications are activated by the physical input unit or by the touch input unit. In other words, the user is able to activate the applications by the physical input unit when the touch input unit fails or activate the applications by the touch input unit when the physical input unit fails and thus ensure that the applications can always be executed.

Referring to FIG. 3, there is shown a schematic view of the input device according to the first embodiment of the present invention. As shown in FIG. 3, an input device 10 comprises a touch input unit 12, a physical input unit 14, and a control unit 16. The touch input unit 12 is adapted to generate a touch signal TS. For example, if the touch input unit 12 is touched, the touch input unit 12 will generate the touch signal TS according to a change in the touching pressure (on a resistive touch panel monitor, for example) or a change in capacitance (of a capacitive touch panel monitor, for example).

The physical input unit 14 is superimposed on the touch input unit 12 and spaced apart from the touch input unit 12 by a distance d. The physical input unit 14 is adapted to generate a control signal CS. Referring to FIG. 4, there is shown a schematic view of the detailed structure of the physical input unit 14 in FIG. 3. As shown in FIG. 4, the physical input unit 14 has a pressing side 142, a frame 144, a resilient body 146, and a touch switch 148. The pressing side 142 is disposed on one side of the frame 144. The touch switch 148 is peripherally disposed at the frame 144. The resilient body 146 is centrally disposed at the frame 144. Given the aforesaid structure, an external force can be exerted upon the pressing side 142 supported by the frame 144, and the touch switch 148 is peripherally disposed at the frame 144 to avoid compromising the manifestation of the touch input unit 14. In addition, given the separation of the resilient body 146 and the touch switch 148, the physical input unit 14 restores to its uncompressed state as soon as a press given to the physical input unit 14 vanishes. Hence, due to the aforesaid structure, the physical input unit 14 in operation can be switched between two states. Furthermore, the physical input unit 14 is made of a transparent material, such that the touch input unit 12 disposed in the physical input unit 14 is visible.

Referring to FIG. 3, the control unit 16 is electrically connected to the touch input unit 12 and the physical input unit 14. The control unit 16 is adapted to activate an action according to the touch signal TS or the control signal CS. For example, the control unit 16 functions as a logical operator for determining whether to activate an action by means of the touch signal TS or the control signal CS according to the voltage level of the control signal CS or the touch signal TS. In other words, the control unit 16 exercises control over an action according to the touch signal TS, the control signal CS, or a combination thereof.

Referring to FIG. 5, there is shown a schematic view of the input device according to the second embodiment of the present invention. As shown in FIG. 5, in addition to the touch input unit 12, the physical input unit 14, and the control unit 16 previously described in the aforesaid embodiment, an input device 10′ further comprises a touch display panel 18 for displaying the touch input unit 12. For example, the touch input unit 12 is linked to an application AP installed on a portable electronic device (not shown), and the touch input unit 12 is displayed on the touch display panel 18. In addition, an icon (not shown) for indicating the application AP is formed on the touch input unit 12.

Furthermore, in another embodiment, the touch display panel 18 is defined with a control region 182, such that the touch input unit 12 is displayed within the control region 182. The control region 182 occupies a portion of the touch display panel 18, and the occupied portion is merely intended to display the touch input unit 12 rather than the contents of the application AP executed.

Referring to FIG. 6, there is shown a schematic view of a monitor 20 having an input device according to the first embodiment of the present invention. As shown in FIG. 6, the monitor 20 comprises a touch display panel 22, a physical input unit 24, and a control unit 26. The touch display panel 22 displays a touch input unit 28. The touch input unit 28 generates the touch signal TS. In an embodiment, the monitor 20 having an input device is further defined with a control region 222, and the touch input unit 28 is displayed within the control region 222.

The physical input unit 24 is disposed on the touch display panel 22. The physical input unit 24 is superimposed on the touch input unit 28. The physical input unit 24 is spaced apart from the touch display panel 22 by a distance (not shown). The physical input unit 24 is adapted to generate the control signal CS. In an embodiment, the physical input unit 24 comprises, as it does in FIG. 4, the pressing side 142, the frame 144, the resilient body 146, and the touch switch 148. The pressing side 142 is disposed on one side of the frame 144. The touch switch 148 is peripherally disposed at the frame 144. The resilient body 146 is centrally disposed at the frame 144. The physical input unit 24 is made of a transparent material, such that the touch input unit 28 disposed in the physical input unit 24 is visible.

The control unit 26 is electrically connected to the physical input unit 24 and the touch display panel 22. The control unit 26 is adapted to activate an action according to the control signal CS or the touch signal TS. For example, the control unit 26 functions as a logical operator.

Compared with the prior art, the present invention provides an input device and a monitor having the input device, wherein the coupling of a touch input unit and a physical input unit enables the applications to be executed by means of the physical input unit even if it is impossible for the applications to be activated by the touch input unit and enables the applications to be executed by means of the touch input unit even if it is impossible for the applications to be activated by the physical input unit, thereby preventing a breakdown which might otherwise happen because the applications cannot be executed as a result of a failure of the touch input unit or the physical input unit.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. An input device, comprising:
a touch input unit for generating a touch signal;
a physical input unit superimposed on the touch input unit and spaced apart therefrom by a distance for generating a control signal; and
a control unit electrically connected to the physical input unit and the touch input unit for activating an action based on the control signal and the touch signal.

2. The input device of claim 1, further comprising a touch display panel for displaying the touch input unit.

3. The input device of claim 2, wherein the touch display panel is defined with a control region for displaying the touch input unit therein.

4. The input device of claim 1, wherein the physical input unit has a pressing side, a frame, a resilient body, and a touch switch, the pressing side being disposed on a side of the frame, the touch switch being peripherally disposed at the frame, and the resilient body being centrally disposed at the frame.

5. The input device of claim 1, wherein the physical input unit is made of a transparent material.

6. The input device of claim 1, wherein the control unit functions as a logical operator.

7. A monitor having an input device, comprising:
a touch display panel for displaying a touch input unit adapted to generate a touch signal;
a physical input unit disposed on the touch display panel, superimposed on the touch input unit, spaced apart from the touch display panel by a distance, and adapted to generate a control signal; and
a control unit electrically connected to the physical input unit and the touch display panel for activating an action based on the control signal and the touch signal.

8. The monitor of claim 7, wherein the physical input unit has a pressing side, a frame, a resilient body, and a touch switch, the pressing side being disposed on a side of the frame, the touch switch being peripherally disposed at the frame, and the resilient body being centrally disposed at the frame.

9. The monitor of claim 7, wherein the physical input unit is made of a transparent material.

10. The monitor of claim 7, wherein the control unit functions as a logical operator.

11. The monitor of claim 7, wherein the touch display panel is defined with a control region for displaying the touch input unit therein.
